(19) United States
(12) Patent Application Publication
(10) Pub. No.: US 2025/0111418 A1
(43) Pub. Date: Apr. 3, 2025

(54) SYSTEMS AND METHODS FOR AUTOMATED ENROLLMENT ORCHESTRATION

(71) Applicant: Synchrony Bank, Stamford, CT (US)

(72) Inventors: Jake Miller, Stamford, CT (US); Joseph Gauthier, Stamford, CT (US); Stephen Rodgers, Stamford, CT (US); Shruti Joshi, Stamford, CT (US)

(21) Appl. No.: 18/756,331

(22) Filed: Jun. 27, 2024

Related U.S. Application Data
(60) Provisional application No. 63/586,152, filed on Sep. 28, 2023.

(51) Int. Cl. G06Q 30/0601

(52) U.S. Cl. CPC G06Q 30/0621; G06Q 20/24; G06Q 40/03

(57) ABSTRACT

Imaging systems and techniques are described. In some examples, an imaging system receives an image captured by an image sensor. The imaging system determines that an image region in the image includes a depiction of an object of a specified category. The imaging system adjusts a hue (and/or saturation and/or brightness) of at least one pixel of the depiction of the object in the image region to a specified hue (and/or saturation and/or brightness) to generate a processed image.

### CROSS-REFERENCE TO RELATED APPLICATIONS

The present invention claims the priority benefit of U.S. Provisional Patent Application 63/586,152 filed Sep. 28, 2023 and titled “Systems and Methods for Automated Enrollment Orchestration,” the disclosure of which is incorporated by reference herein.

### FIELD

This disclosure is related to automated enrollment orchestration onto a transaction processing system. More specifically, this disclosure relates to systems and methods of generating and/or customizing a configuration for an offering based on previously-generated configuration(s) for product type(s), partner(s), merchant(s), and the like.

### BACKGROUND

Transaction processing systems can assist merchants with processing purchases or other transactions with customers. In some cases, transaction processing systems can also offer customers loans or other services to assist with a purchase. In some cases, if a merchant wants to offer, to customers, an offering (e.g., type of transaction) that is new to the merchant, a lengthy onboarding process can delay the start of the offering. The onboarding process for the offering can focus on obtaining information for generating a configuration for the offering.

### BRIEF SUMMARY

Systems and techniques are described for automating enrollment orchestration, for instance to automatically generate and/or configure a configuration for an offering for a merchant so that the merchant and start providing the offering to customers more quickly and efficiently. In some examples, a system can identify an offering to be offered by an entity. The offering is part of a product category (e.g., of financial product). The system can retrieve a predetermined product category configuration associated with the product category and a predetermined entity configuration associated with the entity. The predetermined product category configuration includes a first set of one or more settings for offerings in the product category. The predetermined entity configuration includes a second set of one or more settings for offerings associated with the entity. The system can analyze information associated with the offering to generate an evaluation of the offering relative to the predetermined product category configuration and the predetermined entity configuration. The system can generate an offering configuration for the offering by combining a subset of the first set of one or more settings with a subset of the second set of one or more settings based on the evaluation. The offering configuration includes a third set of settings. The system can provide the offering on behalf of the entity and according to the third set of settings. The system can update an analysis engine used to generate the evaluation based on feedback associated with the offering as provided on behalf of the entity.

According to at least one example, a method is provided for automated enrollment orchestration. The method includes: identifying an offering to be offered by an entity, wherein the offering is part of a product category; retrieving a predetermined product category configuration associated with the product category, wherein the predetermined product category configuration includes a first set of one or more settings for offerings in the product category; retrieving a predetermined entity configuration associated with the entity, wherein the predetermined entity configuration includes a second set of one or more settings for offerings associated with the entity; analyzing information associated with the offering to generate an evaluation of the offering relative to the predetermined product category configuration and the predetermined entity configuration; generating an offering configuration for the offering by combining a subset of the first set of one or more settings with a subset of the second set of one or more settings based on the evaluation, wherein the offering configuration includes a third set of settings; providing the offering on behalf of the entity and according to the third set of settings; and updating an analysis engine used to generate the evaluation based on feedback associated with the offering as provided on behalf of the entity.

In another example, an apparatus for automated enrollment orchestration is provided that includes at least one memory and at least one processor coupled to the at least one memory. The at least one processor is configured to: identify an offering to be offered by an entity, wherein the offering is part of a product category; retrieve a predetermined product category configuration associated with the product category, wherein the predetermined product category configuration includes a first set of one or more settings for offerings in the product category; retrieve a predetermined entity configuration associated with the entity, wherein the predetermined entity configuration includes a second set of one or more settings for offerings associated with the entity; analyze information associated with the offering to generate an evaluation of the offering relative to the predetermined product category configuration and the predetermined entity configuration; generate an offering configuration for the offering by combining a subset of the first set of one or more settings with a subset of the second set of one or more settings based on the evaluation, wherein the offering configuration includes a third set of settings; provide the offering on behalf of the entity and according to the third set of settings; and update an analysis engine used to generate the evaluation based on feedback associated with the offering as provided on behalf of the entity.

In another example, a non-transitory computer-readable medium is provided that has stored thereon instructions that, when executed by one or more processors, cause the one or more processors to: identify an offering to be offered by an entity, wherein the offering is part of a product category; retrieve a predetermined product category configuration associated with the product category, wherein the predetermined product category configuration includes a first set of one or more settings for offerings in the product category; retrieve a predetermined entity configuration associated with the entity, wherein the predetermined entity configuration includes a second set of one or more settings for offerings associated with the entity; analyze information associated with the offering to generate an evaluation of the offering relative to the predetermined product category configuration and the predetermined entity configuration; generate an offering configuration for the offering by combining a subset of the first set of one or more settings with a subset of the second set of one or more settings based on the evaluation, wherein the offering configuration includes a third set of settings; provide the offering on behalf of the entity and according to the third set of settings; and update an analysis engine used to generate the evaluation based on feedback associated with the offering as provided on behalf of the entity.

In another example, an apparatus for automated enrollment orchestration is provided. The apparatus includes: means for identifying an offering to be offered by an entity, wherein the offering is part of a product category; means for retrieving a predetermined product category configuration associated with the product category, wherein the predetermined product category configuration includes a first set of one or more settings for offerings in the product category; means for retrieving a predetermined entity configuration associated with the entity, wherein the predetermined entity configuration includes a second set of one or more settings for offerings associated with the entity; means for analyzing information associated with the offering to generate an evaluation of the offering relative to the predetermined product category configuration and the predetermined entity configuration; means for generating an offering configuration for the offering by combining a subset of the first set of one or more settings with a subset of the second set of one or more settings based on the evaluation, wherein the offering configuration includes a third set of settings; means for providing the offering on behalf of the entity and according to the third set of settings; and means for updating an analysis engine used to generate the evaluation based on feedback associated with the offering as provided on behalf of the entity.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following drawing figures:

FIG. 1 is a block diagram illustrating an example architecture of a transaction processing system with various special-purpose computer systems and data stores performing a process of onboarding an entity, in accordance with some examples;

FIG. 2 is a block diagram illustrating an example architecture of a configuration processing system for generating an offering configuration for an offering for an entity according to a hierarchy of configurations in a special-purpose configuration control system, in accordance with some examples;

FIG. 3 is a block diagram illustrating an example of a data architecture of various types of configurations and data transfers used by a special-purpose configuration control system, in accordance with some examples;

FIG. 4 is a block diagram illustrating an example of a configuration processing system for intelligent selection and/or combination of settings for an offering configuration from settings associated with a product type configuration, a partner configuration, and a local configuration, in accordance with some examples;

FIG. 5 is a block diagram illustrating an example of a configuration processing system for intelligent customization of settings in an offering configuration based on elements of user information to generate a customized offering configuration, in accordance with some examples;

FIG. 6 is a block diagram illustrating an example of a machine learning system for training and use of one or more machine learning model(s) used to generate one or more offering configurations, and/or to customize the one or more offering configurations to generate one or more customized offering configurations, in accordance with some examples;

FIG. 7 is a flow diagram illustrating a process for automated enrollment orchestration, in accordance with some examples; and

FIG. 8 is a diagram illustrating an example of a computing system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

Transaction processing systems can assist merchants with processing purchases or other transactions with customers. In some cases, transaction processing systems can also offer customers loans or other services to assist with a purchase. In some cases, if a merchant wants to offer, to customers, an offering (e.g., type of transaction) that is new to the merchant, a lengthy onboarding process can delay the start of the offering. The onboarding process for the offering can focus on obtaining information for generating a configuration for the offering.

Systems and techniques are described for automating enrollment orchestration, for instance to automatically generate and/or configure a configuration for an offering for a merchant so that the merchant and start providing the offering to customers more quickly and efficiently. In some examples, a system can identify an offering to be offered by an entity. The offering is part of a product category (e.g., of financial product). The system can retrieve a predetermined product category configuration associated with the product category and a predetermined entity configuration associated with the entity. The predetermined product category configuration includes a first set of one or more settings for offerings in the product category. The predetermined entity configuration includes a second set of one or more settings for offerings associated with the entity. The system can analyze information associated with the offering to generate an evaluation of the offering relative to the predetermined product category configuration and the predetermined entity configuration. The system can generate an offering configuration for the offering by combining a subset of the first set of one or more settings with a subset of the second set of one or more settings based on the evaluation. The offering configuration includes a third set of settings. The system can provide the offering on behalf of the entity and according to the third set of settings. The system can update an analysis engine used to generate the evaluation based on feedback associated with the offering as provided on behalf of the entity.

The automated enrollment orchestration systems and techniques (e.g., for transaction processing system(s)) described herein provide a number of technical improvements over prior transaction processing onboarding systems, for instance allowing a new offering to be onboarded for a merchant more quickly and efficiently, with little to no input from any user, dynamically, in real-time, and in an automated fashion based on received information (e.g., information about processed transactions, about the merchant, about the product or offering type, about the partner, about changes to other configuration(s), and the like) and as that information continues to be received and analyzed. The automated enrollment orchestration systems and techniques described herein provide more customized, personalized, and/or tailored configurations for onboarding a new offering for a merchant. For instance, the configurations are customized, personalized, and/or tailored to the product type or offering type of the offering, a partner associated with the merchant, a local store associated with the merchant, one or more customers, or a combination thereof. The automated enrollment orchestration systems and techniques described herein provide more flexibility, being able to generate and/or customize configurations for any type of offering.

Various aspects of the application will be described with respect to the figures.

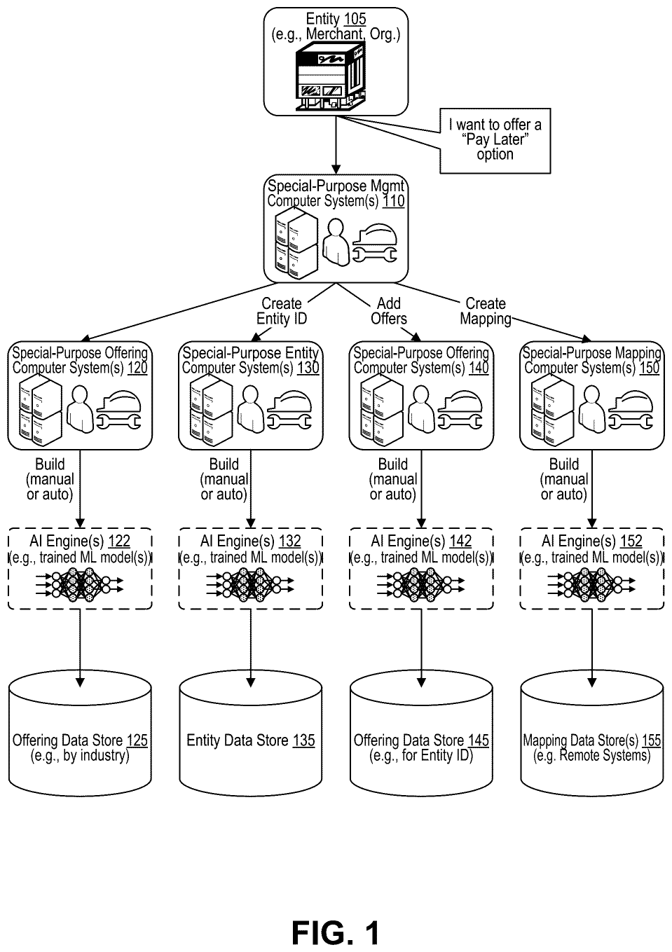

FIG. 1 is a block diagram illustrating an example architecture of a transaction processing system 100 with various special-purpose computer systems and data stores performing a process of onboarding an entity 105. The transaction processing system 100 includes one or more special-purpose management computer system(s) 110 that receives an input from the entity 105 (e.g., through a user interface from a representative of the entity 105). The entity 105 can be, for instance, a merchant, a store, an organization, a business, or a combination thereof. The input identifies an offering (e.g., a financial product) that the entity 105 would like to offer (e.g., that will be newly offered by the entity 105 to its customers). In an illustrative example, the offering can be an option for a customer of the entity 105 to “pay later” for a product or service of the entity 105 (e.g., pay for a product or service in installments over time after an initial purchase) but still receive the product or service from the entity 105.

The transaction processing system 100 includes one or more special-purpose computing system(s) 120 associated with an industry. The special-purpose management computer system(s) 110 and special-purpose offering computer system(s) 120 identify at least one industry that the entity 105 belongs to, and build a configuration in an offering data store 125, either manually or automatically using one or more artificial intelligence engine(s) 122. The offering data store 125 can store offerings, associated configurations, and the like. In some examples, the offering data store 125 is arranged, sorted, segregated, and/or organized by industry, identifying offerings for numerous entities (e.g., merchants, organizations, or other entities) within one or more industries. In some examples, the offering data store 125 includes records that identify the offering (e.g., the “pay later” product) and include an identifier of the entity 105 (e.g., an entity identifier or Entity ID) in association with the identification of the offering. In some examples, the special-purpose offering computer system(s) 120 can add the record corresponding to the offering (e.g., to the offering data store 125) based on receiving interactions through user interface(s) of the special-purpose offering computer system(s) 120 (e.g., from one or more users interacting with the special-purpose offering computer system(s) 120) to interface with the offering data store 125. In some examples, the special-purpose offering computer system(s) 120 can add the record corresponding to the offering automatically, for instance based on output(s) generated by the artificial intelligence engine(s) 122 in response to input of contextual data about the entity 105, the offering, the industry, other entities, other offerings, other record(s) added to one or more of the other data store(s) of the transaction processing system 100, other record(s) added to one or more external data store(s) that are external to the transaction processing system 100, other types of data discussed herein, or a combination thereof.

The transaction processing system 100 includes one or more special-purpose computing system(s) 130 associated with various entities (including the entity 105) that are registered with the transaction processing system 100. The one or more special-purpose computing system(s) 130 are associated with an entity data store 135. If the entity 105 is new to the transaction processing system 100 (e.g., not already registered with the transaction processing system 100 in the entity data store 135, for instance based on no records existing with an entity identifier for the entity 105 in the entity data store 135), the one or more special-purpose computing system(s) 120 generates an entity identifier (entity ID) for the entity 105 and adds a record storing the entity identifier in the entity data store 135, for instance along with data about the entity 105 (e.g., identifying industry of the entity 105, products and/or services provided by the entity 105 to consumers, offerings that the entity 105 is using, and the like). In some examples, the special-purpose entity computer system(s) 130 can generate the entity identifier corresponding to the entity 105 (e.g., and/or add a record corresponding to the entity identifier to the entity data store 135) based on receiving interactions through user interface(s) of the special-purpose entity computer system(s) 130 (e.g., from one or more users interacting with the special-purpose entity computer system(s) 130) to interface with the entity data store 135. In some examples, the special-purpose entity computer system(s) 130 can generate the entity identifier corresponding to the entity 105 (e.g., and/or add a record corresponding to the entity identifier to the entity data store 135) automatically, for instance based on output(s) generated by the artificial intelligence engine(s) 132 in response to input of contextual data about the entity 105, the offering, the industry, other entities, other offerings, other record(s) added to one or more of the other data store(s) of the transaction processing system 100, other record(s) added to one or more external data store(s) that are external to the transaction processing system 100, other types of data discussed herein, or a combination thereof.

The transaction processing system 100 includes one or more special-purpose computing system(s) 140 associated with the entity 105. The one or more special-purpose computing system(s) 140 are associated with an offering data store 145 that stores offerings specific to the entity 105, for instance offerings that are associated with the entity 105 as indicated by the offering data store 125. In some examples, the offering data store 145 may represent a subset of the offering data store 125 that is specific to the entity 105. In some examples, the special-purpose offering computer system(s) 140 can add the record corresponding to the offering (e.g., to the offering data store 145) based on receiving interactions through user interface(s) of the special-purpose offering computer system(s) 140 (e.g., from one or more users interacting with the special-purpose offering computer system(s) 140) to interface with the offering data store 145. In some examples, the special-purpose offering computer system(s) 140 can add the record corresponding to the offering automatically, for instance based on output(s) generated by the artificial intelligence engine(s) 142 in response to input of contextual data about the entity 105, the offering, the industry, other entities, other offerings, other record(s) added to one or more of the other data store(s) of the transaction processing system 100, other record(s) added to one or more external data store(s) that are external to the transaction processing system 100, other types of data discussed herein, or a combination thereof.

The transaction processing system 100 includes one or more special-purpose computing system(s) 150 associated with the entity 105. The one or more special-purpose computing system(s) 150 are associated with mapping data store(s) 155 associated with remote system(s). In some examples, the mapping data store(s) 155 include, and/or are associated with, a Central Application Tracking System (CATS). The special-purpose computing system(s) 150 can add record(s) to the mapping data store(s) 155 mapping the entity 105 to the offering, for instance, so that other systems that interface with the transaction processing system 100 (e.g., the computer systems of the entity 105 itself) can understand that the entity 105 now offers, and/or is associated with, the offering. In some examples, the special-purpose computing system(s) 150 and/or the mapping data store(s) 155 are associated with one or more application programming interface(s) (API(s)) through which system(s) and/or software application(s) external to the transaction processing system 100 can access information about the entity 105, the offering, and the like. In some examples, the special-purpose mapping computer system(s) 150 can add the record corresponding to the entity 105 and/or the offering (e.g., to the mapping data store(s) 155) based on receiving interactions through user interface(s) of the special-purpose mapping computer system(s) 150 (e.g., from one or more users interacting with the special-purpose mapping computer system(s) 150) to interface with the offering data store 155. In some examples, the special-purpose mapping computer system(s) 150 can add the record corresponding to the entity 105 and/or the offering automatically, for instance based on output(s) generated by the artificial intelligence engine(s) 152 in response to input of contextual data about the entity 105, the offering, the industry, other entities, other offerings, other record(s) added to one or more of the other data store(s) of the transaction processing system 100, other record(s) added to one or more external data store(s) that are external to the transaction processing system 100, other types of data discussed herein, or a combination thereof.

The AI engines (e.g., AI engine(s) 122, AI engine(s) 132, AI engine(s) 142, and/or AI engine(s) 152) can include, for instance, one or more neural network (NNs), one or more convolutional neural networks (CNNs), one or more trained time delay neural networks (TDNNs), one or more deep networks, one or more autoencoders, one or more deep belief nets (DBNs), one or more recurrent neural networks (RNNs), one or more generative adversarial networks (GANs), one or more conditional generative adversarial networks (cGANs), one or more other types of neural networks, one or more trained support vector machines (SVMs), one or more trained random forests (RFs), one or more computer vision systems, one or more deep learning systems, one or more classifiers, one or more transformers, one or more large language models (LLMs), or combinations thereof. Examples of LLMs that can be used can include, for instance, a Generative Pre-Trained Transformer (GPT) (e.g., GPT-2, GPT-3, GPT-3.5, GPT-4, etc.). DaVinci, an LLM using Massachusetts Institute of Technology (MIT) langchain, Google® Bard®, Large Language Model Meta AI (LLaMA), another LLM, or a combination thereof.

Within FIG. 1, a graphic representing the various AI engines (e.g., AI engine(s) 122, AI engine(s) 132, AI engine(s) 142, and/or AI engine(s) 152) illustrates a set of circles connected to another. Each of the circles can represent a node, a neuron, a perceptron, a layer, a portion thereof, or a combination thereof, for instance of a NN or other ML model. The circles are arranged in columns. The leftmost column of white circles represent an input layer. The rightmost column of white circles represent an output layer. Two columns of shaded circled between the leftmost column of white circles and the rightmost column of white circles each represent hidden layers. The lines between nodes can represent weights between nodes. Weights can be added, removed, strengthened, weakened, or otherwise updated as the AI engines are updated or further trained based on new training data.

The data stores (e.g., offering data store 125, entity data store 135, offering data store 145, and/or other data store(s) 155) can include, for instance, database(s), table(s), spreadsheet(s), list(s), array(s), arraylist(s), heap(s), tree(s), dictionar (ies), linked list(s), hash table(s), graph(s), stack(s), queue(s), trie(s), queap(s), distributed ledger(s), blockchain ledger(s), directed acyclic graph(s) (DAGs), data model(s), record(s), linked data structure(s), other data structure(s), or combination(s) thereof.

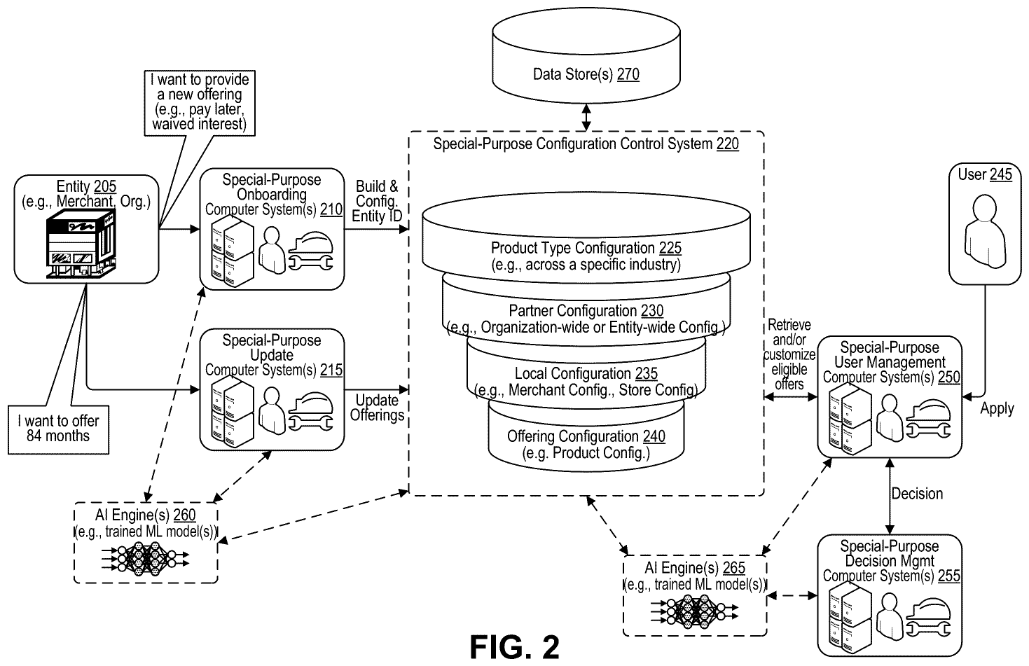

FIG. 2 is a block diagram illustrating an example architecture of a configuration processing system 200 for generating an offering configuration 240 for an offering for an entity 205 according to a hierarchy of configurations in a special-purpose configuration control system 220. In some examples, the entity 205 is the entity 105. The offering of FIG. 2 can be an example of the offering of FIG. 1. In an illustrative example, the offering of FIG. 2 can be a Pay Later offering with waived interest.

The configuration processing system 200 includes one or more special-purpose onboarding computer system(s) 210 that receive a request from the entity 205, for instance from a user associated with the entity 205 through a user interface of the special-purpose onboarding computer system(s) 210 and/or from a computing system associated with the entity 205 over a network connection between the computing system associated with the entity 205 and the special-purpose onboarding computer system(s) 210. The special-purpose onboarding computer system(s) 210 are configured to generate an entity identifier for the entity 205 (if the entity 205 does not already have one), store records mapping the offering to the entity identifier in one or more data stores of a special-purpose configuration control system 220, generate an offering configuration 240 for use of the offering by the entity 205, and/or store the offering configuration 240 in one or more data stores of a special-purpose configuration control system 220.

In some examples, configuration processing system 200 includes one or more special-purpose update computer system(s) 215 that receive a second request from the entity 205, for instance from a user associated with the entity 205 through a user interface of the special-purpose update computer system(s) 215 and/or from a computing system associated with the entity 205 over a network connection between the computing system associated with the entity 205 and the special-purpose update computer system(s) 215. The second request can be a request to update the offering and/or the offering configuration 240. For instance, in an illustrative example, the second request can be a request to update the offering (e.g., the Pay Later offering with waived interest) to offer payment to be waived for a duration of 84 months (e.g., which may have been previously set to a different amount of time, such as 60 months). In some examples, the one or more special-purpose onboarding computer system(s) 210 and the one or more special-purpose update computer system(s) 215 share at least one or more computing system(s). In some examples, the first request may not specify the waived interest aspect, and the waived interest aspect may also be an update to the offering that is requested through the one or more special-purpose onboarding computer system(s) 210 and/or the one or more special-purpose update computer system(s) 215. In some examples, the one or more special-purpose onboarding computer system(s) 210 and/or the special-purpose update computer system(s) 215 can be associated with a customer relationship management (CRM) service.

The special-purpose configuration control system 220 includes a hierarchy of configurations that can be used by the special-purpose onboarding computer system(s) 210 to generate, customize, and/or update the offering configuration 240. The hierarchy of configurations includes a product type configuration 225, a partner configuration 230, a local configuration 235, and an offering configuration 240. The product type configuration 225 identifies settings used for offerings of a specific product type (e.g., financial products such as a “pay later” loan product type) across at least one industry (e.g., restaurants, grocery stores, hardware stores, drug stores, and/or other industries). The partner configuration 230 identifies settings used for offerings across a partner entity (e.g., a specific brand or merchant, for instance a partner entity that runs multiple stores). The local configuration 235 identifies settings used by a specific store or merchant of the partner entity associated with the partner configuration 230. The offering configuration 240 is generated, updated, and/or customized for a user 245 using the configuration processing system 200, in some cases according to the hierarchy of the configurations in the special-purpose configuration control system 220. For instance, the offering configuration 240 can be generated by importing settings from the product type configuration 225, the partner configuration 230, and/or the local configuration 235. In examples where the settings are imported according to hierarchy, then settings that are closer to the offering configuration 240 in the hierarchy can be prioritized over settings that are farther from the offering configuration 240 in the hierarchy. For instance, a setting in the local configuration 235 can be prioritized over a corresponding setting in the partner configuration 230. Similarly, a setting in the partner configuration 230 can be prioritized over a corresponding setting in the product type configuration 225. Similarly, a setting in the local configuration 235 can be prioritized over a corresponding setting in the product type configuration 225. In some examples, settings that are farther to the offering configuration 240 in the hierarchy can be instead prioritized over settings that are closer from the offering configuration 240 in the hierarchy.

Examples of settings in the configurations (e.g., the product type configuration 225, the partner configuration 230, the local configuration 235, and/or the offering configuration 240) can include, for instance, a duration of time for the “Pay Later” loan (e.g., 60 months, 84 months), an annual percentage rate (APR) (e.g., 19.99%), an interest amount, how to calculate certain payments (e.g., what equations and/or variable values to use), a minimum amount (e.g., price and/or cost) for eligibility for the offering or offering type, a maximum amount (e.g., price and/or cost) for eligibility for the offering or offering type, one or more identifiers (e.g., of the offering, of the partner entity, of the industry, of the merchant, of the store, of the entity 205, of a user, and the like), merchant discount rate (MDR), mapping to another system, or some combination thereof.

By having the offering configuration 240 inherit settings from the product type configuration 225, the partner configuration 230, and/or the local configuration 235, the offering can be onboarded for the entity 205 quickly, efficiently, and in a way that is consistent with how similar offerings have been configured across the industry, by the partner entity, at a specific local store, or some combination thereof. An offering configuration 240 generated in this way is immediately functional, as opposed to a blank configuration that would be non-functional until configured by the entity 205.

In an illustrative example, the entity 205 may be a particular store in Los Angeles, California of a chain of furniture stores under the brand XYZ Furniture. The entity 205 (the Los Angeles XYZ Furniture store) can identify that it wants to offer a “Pay Later” offering to its customers, allowing them to purchase a piece of furniture and pay for it 84 months later (e.g., in installments or otherwise). The special-purpose configuration control system 220 can create a data structure for the offering configuration 240 for the “Pay Later” offering for the entity 205 (the Los Angeles XYZ Furniture store). The local configuration 235 can include settings used by the entity 205 (the Los Angeles XYZ Furniture store) for similar offerings, and the special-purpose configuration control system 220 can import one or more settings from the local configuration 235 into the offering configuration 240. The partner configuration 230 can include settings used by the partner entity (e.g., XYZ Furniture as a whole) for this offering and/or similar offerings. To the extent there are settings in the partner configuration 230 that might be missing from the local configuration 235, the special-purpose configuration control system 220 can import those settings from the partner configuration 230 into the offering configuration 240. The product type configuration 225 can include settings used across the industry (e.g., furniture stores) for this offering and/or similar offerings. To the extent there are settings in the product type configuration 225 that might be missing from the local configuration 235 and/or the partner configuration 230, the special-purpose configuration control system 220 can import those settings from the partner configuration 230 into the product type configuration 225. By importing settings into the offering configuration 240 from configurations across the hierarchy of configurations in this way, the special-purpose configuration control system 220 can generate an offering configuration 240 that is complete, functional, and is most likely to match what the entity 205 expects to use for the offering.

In some examples, the special-purpose configuration control system 220 can update the offering configuration 240 automatically, dynamically, and/or in real-time as changes continue to be made to the local configuration 235, the partner configuration 230, and/or the product type configuration 225. This can also help to keep the offering configuration 240 consistent and/or aligned with how the same offering and/or similar offerings are offered by the same entity 205 (e.g., in the same store), by the same partner entity, and/or across the same industry. For instance, the special-purpose configuration control system 220 can poll for updates to the local configuration 235, the partner configuration 230, and/or the product type configuration 225—and if an update is found, the special-purpose configuration control system 220 can update the offering configuration 240 automatically, dynamically, and/or in real-time as the changes continue to be detected.

While the illustrative example above suggests that the entity 205 may be a particular store of a partner entity, in some examples the entity 205 may be the partner entity itself. In such cases, the local configuration 235 may be missing or disregarded, and the partner configuration 230 may be considered to be the closest configuration to the offering configuration 240 in hierarchy, rather than the local configuration 235.

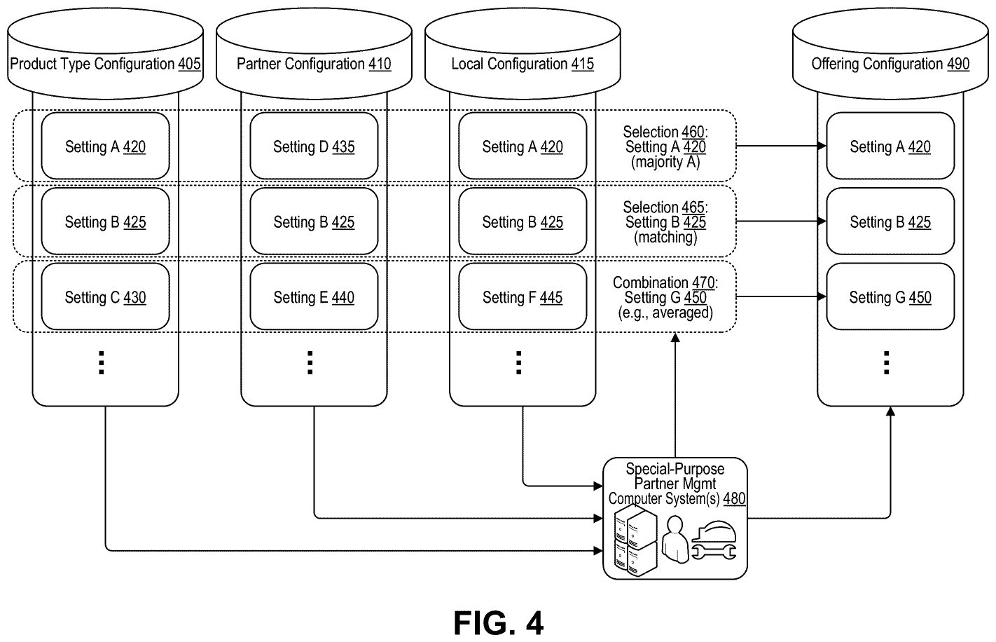

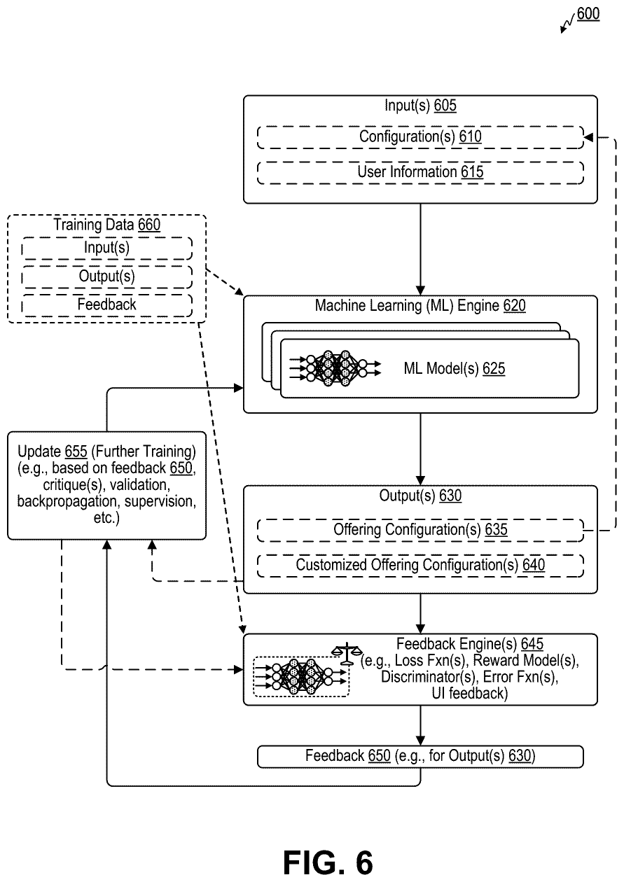

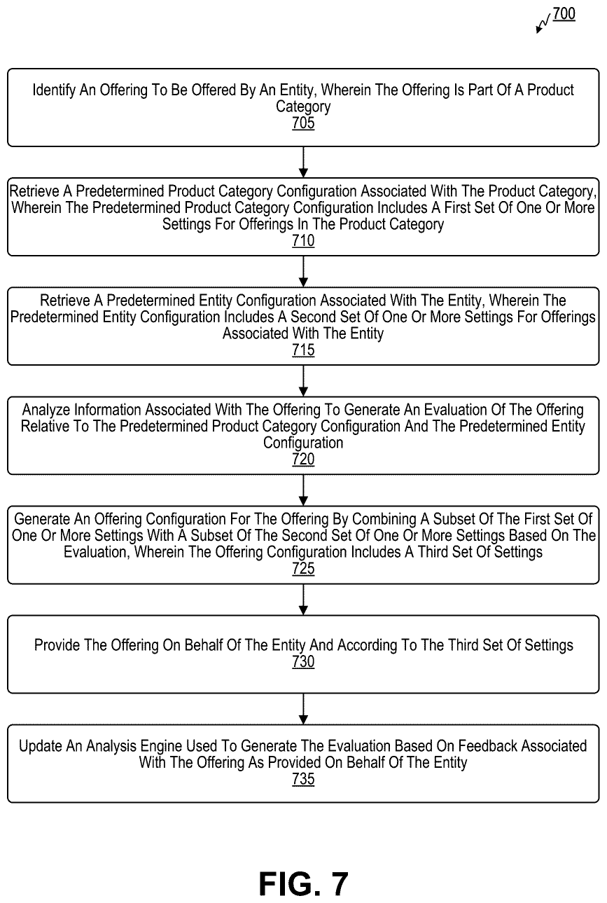

In some examples, the special-purpose configuration control system 220 can select and/or combine settings from the local configuration 235, the partner configuration 230, and/or the product type configuration 225 in various ways (e.g., other than following the hierarchy), for instance selecting based on matching settings, majority of settings, combined (e.g., averaged or merged) settings as in FIG. 4, different hierarchies that are to be followed for certain types of settings (e.g., types of settings where a setting in the product type configuration 225 or the partner configuration 230 should be selected over the corresponding setting in the local configuration 235), and/or using one or more AI engine(s) 260 to select and/or combine settings as illustrated and discussed with respect to FIGS. 4, 6, and/or FIG. 7.

In some examples, the configuration processing system 200 includes AI engine(s) 260 that assist with generating (e.g., selecting setting(s) for) and/or updating the offering configuration 240. In some examples, the AI engine(s) 260 is part of, and/or is used by, the special-purpose onboarding computer system(s) 210, special-purpose update computer system(s) 215, and/or the special-purpose configuration control system 220. As with the AI engine 122, the AI engine 132, the AI engine 142, and/or the AI engine 152, the AI engine(s) 260 can include one or more trained machine learning models. In some examples, the AI engine(s) 260 (e.g., the machine learning models) can be trained to select and/or combine settings for the offering configuration 240 based on input of request(s) received from the entity 205 to generate the offering and/or based on at least a subset of the other configurations in the special-purpose configuration control system 220 (e.g., the product type configuration 225, the partner configuration 230, and/or the local configuration 235). In some examples, the AI engine(s) 260 can include the machine learning model(s) 625 of FIG. 6.

In some examples, the configuration processing system 200 includes one or more special-purpose user management computing system(s) 250 associated with a user 245. The special-purpose user management computing system(s) 250 may receive, through a user interface of the special-purpose user management computing system(s) 250, one or more interaction(s) (e.g., request(s)) from the user 245 indicating that the user 245 requests to apply for the offering (e.g., the “Pay Later” offering associated with the offering configuration 240). The special-purpose user management computing system(s) 250 can retrieve offerings (including corresponding offering configurations such as the offering configuration 240) associated with the entity 205 from the special-purpose configuration control system 220 based on the request from the user 245.

In some examples, the configuration processing system 200 includes one or more special-purpose decision management computing system(s) 255. The special-purpose decision management computing system(s) 255 can determine, out of the offerings (and/or corresponding offering configurations such as the offering configuration 240) associated with the entity 205 retrieved from the special-purpose configuration control system 220 by the special-purpose user management computing system(s) 250, which offerings the user 245 is eligible for based on contextual information associated with the user 245. The contextual information associated with the user 245 can include, for instance, a credit score of the user 245, a transaction history of the user 245, a credit history of the user 245, information about one or more loans that the user 245 has taken out, a loan payment history of the user 245, asset information about one or more assets that the user 245 owns, geographic information about where the user 245 lives and/or works, demographic information about the user 245, similar information about other user(s) who are similar to the user 245, similar information about other user(s) who are contacts of the user 245, or a combination thereof. The contextual information can be retrieved by the special-purpose user management computing system(s) 250 and/or the special-purpose decision management computing system(s) 255 from one or more data stores. In some examples, the one or more data stores can be part of the configuration processing system 200 and/or the special-purpose configuration control system 220.

In some examples, the special-purpose user management computing system(s) 250 and/or the special-purpose decision management computing system(s) 255 can further customize an offering for the user 245 (once the special-purpose decision management computing system(s) 255 has determined that the user 245 is eligible for the offering) based on the contextual information about the user 245 and/or preference(s) of the user 245. For instance, if the offering configuration 240 indicates a “Pay Later” loan term of 84 months for a “Pay Later” offering, but retrieved preference(s) of the user 245 indicate a preference for a loan term of 60 months, then the special-purpose user management computing system(s) 250 and/or the special-purpose decision management computing system(s) 255 can customize the offering configuration 240 to approach of match the preference(s) of the user 245. For instance, the customization of the offering configuration 240 can change the “Pay Later” loan term from 84 months to 72 months (an average of 84 and 60), or even to 60 months.

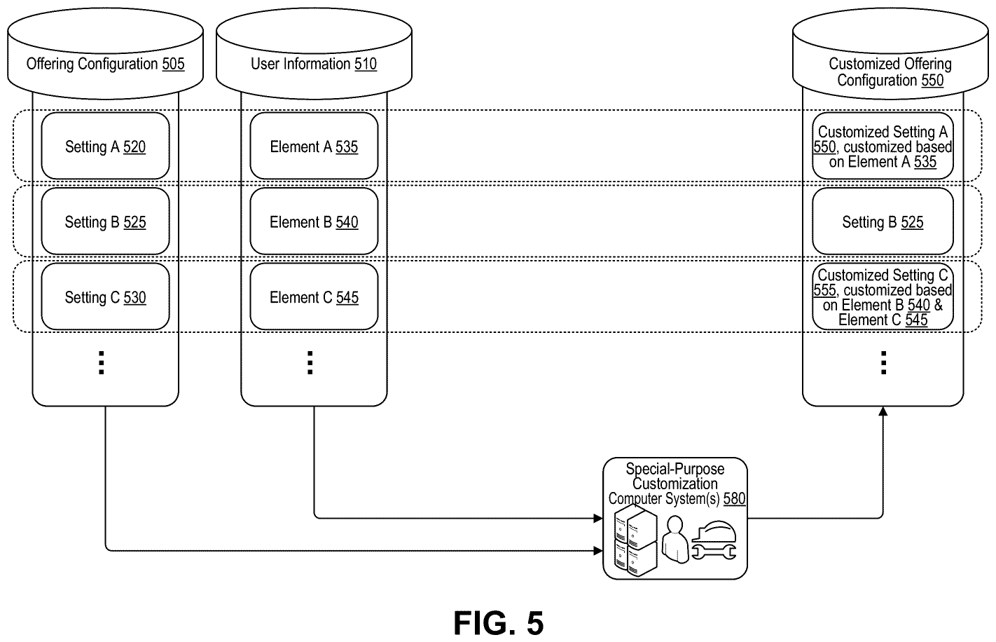

The special-purpose user management computing system(s) 250 and/or the special-purpose decision management computing system(s) 255 can customize the offering configuration 240 for the user 245 in various ways. For instance, in some examples, if the preference(s) of the user 245 align with a setting in another one of the other configurations in the special-purpose configuration control system 220 (e.g., the product type configuration 225, the partner configuration 230, and/or the local configuration 235), the special-purpose user management computing system(s) 250 and/or the special-purpose decision management computing system(s) 255 can customize the offering configuration 240 to modify a corresponding setting from the offering configuration 240 to be equivalent to, or approaching, the aligned setting from the other configuration. In some examples, the special-purpose user management computing system(s) 250 and/or the special-purpose decision management computing system(s) 255 can modify the setting in from the offering configuration 240 to be an average of the existing setting in the offering configuration 240 and the aligned setting from the other configuration. In some examples, the special-purpose user management computing system(s) 250 and/or the special-purpose decision management computing system(s) 255 can customize the offering configuration 240 for the user 245 using one or more AI engine(s) 265 to select and/or combine settings as illustrated and discussed with respect to FIGS. 5, 6 and/or 7.

In some examples, the configuration processing system 200 includes the AI engine(s) 265 that assist with customizing (e.g., selecting and/or combining setting(s) for) the offering configuration 240 for the use 245. In some examples, the AI engine(s) 265 is part of, and/or is used by, the special-purpose user management computing system(s) 250, the special-purpose decision management computing system(s) 255, and/or the special-purpose configuration control system 220. As with the AI engine 122, the AI engine 132, the AI engine 142, the AI engine 152, and/or the AI engine(s) 260, the AI engine(s) 265 can include one or more trained machine learning models. In some examples, the AI engine(s) 265 (e.g., the machine learning models) can be trained to modify settings for the offering configuration 240 based on input of user preferences and/or user context information, and/or based on at least a subset of the other configurations in the special-purpose configuration control system 220 (e.g., the product type configuration 225, the partner configuration 230, and/or the local configuration 235). In some examples, the AI engine(s) 265 can include the machine learning model(s) 625 of FIG. 6.

In some examples, the configuration processing system 200 includes one or more data stores 270 that store at least a subset of the product type configuration 225, at least a subset of the partner configuration 230, at least a subset of the local configuration 235, at least a subset of the offering configuration 240, or a combination thereof. In some examples, the product type configuration 225 stores settings, parameters, and/or configuration details such as product name for a product type, a product code for the product type, a minimum amount for the product type, a maximum amount for the product type, or a combination thereof. In some examples, the partner configuration 230 stores settings, parameters, and/or configuration details such as any of those discussed above with respect to the product type configuration 225 and/or settings, parameters, and/or configuration details such as a partner identifier for a partner entity, a minimum amount for the partner entity, a maximum amount for the partner entity, one or more feature flags associated with the partner entity (e.g., for multi-product (pre-) qualification (MPQ), waived interest, and the like), one or more feature configurations associated with the partner entity (e.g., waived interest minimum, waived interest maximum, and the like), or a combination thereof. In some examples, the local configuration 235 and the offering configuration 240 store settings, parameters, and/or configuration details such as any of those discussed above with respect to the product type configuration 225, the partner configuration 230, and/or settings, parameters, and/or configuration details such as an offer identifier for an offering for a merchant, a promo code for the offering, a credit tier for the offering, a minimum for the merchant and/or for the offering, a maximum for the merchant and/or for the offering, a term for the offering, an annual percentage rate (APR) for the offering, or a combination thereof. In some examples, the one or more data stores 270 store settings, parameters, and/or configuration details such as any of those discussed above with respect to the product type configuration 225, the partner configuration 230, the local configuration 235, the offering configuration 240 and/or settings, parameters, and/or configuration details such as a promotion identifier (ID), a term, an annual percentage rate (APR), a mandatory disclosure regime (MDR), or a combination thereof.

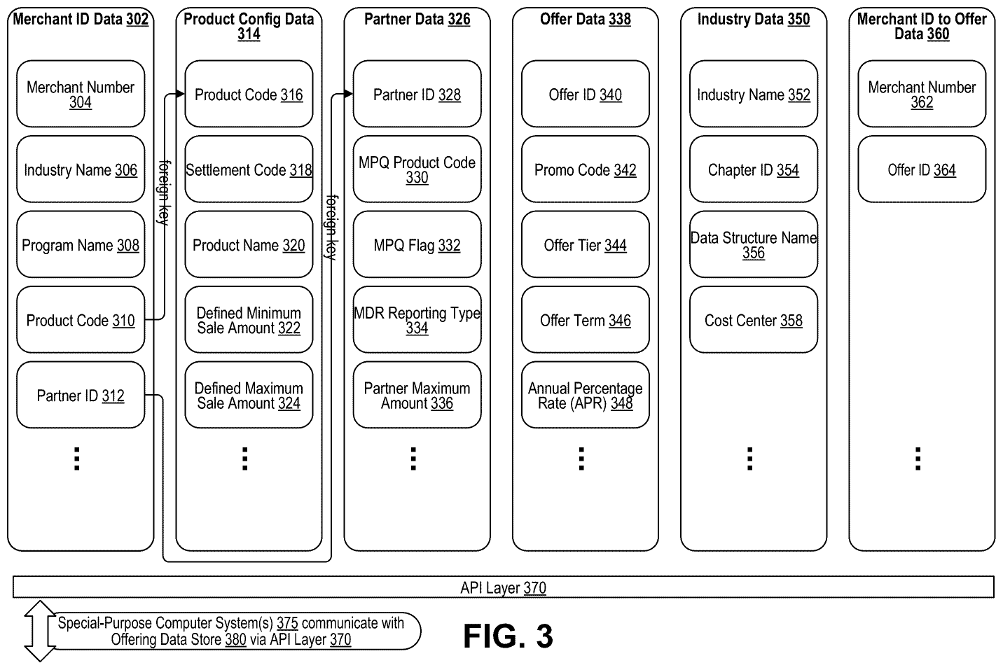

FIG. 3 is a block diagram illustrating an example of a data architecture 300 of various types of configurations and data transfers used by a special-purpose configuration control system 220. The data architecture 300 includes several configurations stored in one or more data structures and/or data stores (e.g., offering data store 125, entity data store 135, offering data store 145, mapping data store(s) 155, special-purpose configuration control system 220, data stores 270, data store 345), each of which can be an example of at least a portion of one of the configurations in the hierarchy in the special-purpose configuration control system 220 (e.g., the product type configuration 225, the partner configuration 230, the local configuration 235, and/or the offering configuration 240). The configurations in the data architecture 300 include the merchant identifier (ID) data 302, the product configuration data 314, the partner data 326, the offer data 338, the industry data 350, and the merchant ID to offer data 360.

Each of the different configurations in the data architecture 300 can include a set of settings and/or parameters. For instance, the merchant identifier (ID) data 302 includes a merchant number 304 for a merchant, an industry name 306 of an industry that the merchant belongs to, a program name 308 for a program that the merchant uses, a product code 310 for a product that the merchant sells, a partner identifier (ID) 312 for a partner entity associated with the merchant, a “doing business as” (DBA) name for the merchant, an address for the merchant, a country for the merchant, a state for the merchant, a city for the merchant, a zip code for the merchant, a phone number for the merchant, an email address for the merchant, a fax number for the merchant, a merchant status of the merchant, a name of a contact (e.g., an executive, president, owner, employee, or other person) associated with the merchant, other settings or parameters or configuration elements discussed herein, or a combination thereof.

The product configuration data 314 includes a product code 316 for a product (e.g., which can match the product code 310 in the merchant ID data 302), a settlement code 318 for the product, a product name 320 for the product, a defined minimum sale amount 322 for the product, a defined maximum sale amount 324 for the product, other settings or parameters or configuration elements discussed herein, or a combination thereof.

The partner data 326 includes partner identifier (ID) 328 for a partner entity (e.g., which can match the partner ID 312 in the merchant ID data 302), a multi-product (pre-) qualification (MPQ) product code 330 for one or more products associated with the partner entity, an MPQ flag associated with the partner entity, a mandatory disclosure regime (MDR) reporting type 334 for the partner entity, a partner maximum amount 336 for the partner entity, a partner minimum amount for the partner entity, other settings or parameters or configuration elements discussed herein, or a combination thereof.

The offer data 338 includes an offer identifier (ID) 340 for an offer or an offering, a promo code 342 for the offer or offering, an offer tier 344 for the offer or offering, an offer term 346 for the offer or offering, an annual percentage rate (APR) 348 for the offer or offering, other settings or parameters or configuration elements discussed herein, or a combination thereof.

The industry data 350 includes an industry name 352 for an industry (e.g., which can match the industry name 306 in the merchant ID data 302), a chapter identifier (ID) 354 associated with the industry, a data structure name or identifier 356 for a data structure associated with the industry (e.g., the offering data store 125, the product type configuration 225), a cost center 358 associated with the industry, other settings or parameters or configuration elements discussed herein, or a combination thereof.

The merchant ID to offer data 360 includes a merchant number 362 associated with a merchant at which an offer or offering is offered (e.g., which can match the merchant number 304 in the merchant ID data 302), an offer ID 364 for the offer or offering (e.g., which can match the offer ID 340 in the offer data 338), other settings or parameters or configuration elements discussed herein, or a combination thereof.

In some examples, the data architecture 300 includes an application programming interface (API) layer 370 through which special-purpose computer system(s) 375 communicate with an offering data store 380 that stores the various configurations, for instance to access and/or modify data (e.g., settings, parameters, and/or configuration details) from the various configurations.

FIG. 4 is a block diagram illustrating an example of a configuration processing system 400 for intelligent selection and/or combination of settings for an offering configuration 490 from settings associated with a product type configuration 405, a partner configuration 410, and a local configuration 415. The product type configuration 405 is an example of the product type configuration 225. The partner configuration 410 is an example of the partner configuration 230. The local configuration 415 is an example of the local configuration 235. The offering configuration 490 is an example of the offering configuration 240. The special-purpose partner management computer system(s) 480 are examples of the special-purpose onboarding computer system(s) 210, the special-purpose update computer system(s) 215, the special-purpose configuration control system 220, the AI engine(s) 260, or a combination thereof.

The product type configuration 405, the partner configuration 410, and the local configuration 415 are each illustrated as including three exemplary parameters that are set to specific settings. These settings are analyzed by the special-purpose partner management computer system(s) 480 to determine corresponding settings for the three exemplary parameters for the offering configuration 490.

For instance, for the first parameter (the top row of settings in FIG. 4), the product type configuration 405 and the local configuration 415 both use a setting A 420, while the partner configuration 410 uses a setting D 435. The special-purpose partner management computer system(s) 480 makes a selection 460 of the setting A 420 for the first parameter (top row) for the offering configuration 490 based on a majority (or plurality) of the configurations using the setting A 420.

For the second parameter (the middle row of settings in FIG. 4), the product type configuration 405, the partner configuration 410, and the local configuration 415 all use a setting B 425. The special-purpose partner management computer system(s) 480 makes a selection 465 of the setting B 425 for the second parameter (middle row) for the offering configuration 490 based on all of the configurations matching (e.g., unanimously and/or majority as in the selection 460) using the setting B 425.

For the third parameter (the bottom row of settings in FIG. 4), the product type configuration 405 uses a setting C 430, the partner configuration 410 uses a setting E 440, and the local configuration 415 uses a setting F 445. The special-purpose partner management computer system(s) 480 generates a combination 470 (e.g., an average, a mean, a median, a mode, a merging, and/or a weighted average) of the setting C 430, the setting E 440, and/or the setting F 445 to generate a setting G 450 for the first parameter (bottom row) for the offering configuration 490. In some examples, the setting G 450 can be generates as a weighted average of the setting C 430, the setting E 440, and/or the setting F 445, with the weights being based on the relative levels of prioritization and/or hierarchy of the product type configuration 405, the partner configuration 410, and/or the local configuration 415. In some examples, the combination 470 can include merging of at least one aspect of the setting C 430 with at least one aspect of the setting E 440 and at least one aspect of the setting F 445 generate the setting G 450.

While it is not illustrated in FIG. 4, in some examples, a setting for the offering configuration 490 can be selected by the special-purpose partner management computer system(s) 480 based on a hierarchy of the prioritization and/or hierarchy of the product type configuration 405, the partner configuration 410, and/or the local configuration 415. For example, if a setting indicates that, for a specific parameter, the local configuration 415 is to be prioritized over the partner configuration 410, and the partner configuration 410 is to be prioritized over the product type configuration 405, then for that parameter, the special-purpose partner management computer system(s) 480 can select the setting for the offering configuration 490 to match the corresponding setting for the parameter in the local configuration 415 if there is a valid setting in the local configuration 415, then to match the corresponding setting for the parameter in the partner configuration 410 if there wasn't a valid setting in the local configuration 415, then to match the corresponding setting for the parameter in the product type configuration 405 if there wasn't a valid setting in the partner configuration 410 or the local configuration 415.

While it is not illustrated in FIG. 4, in some examples, a setting for the offering configuration 490 can be selected based on a scoring evaluation of different settings in the different configurations for a given parameter. For instance, if the product type configuration 405, the partner configuration 410, and the local configuration 415 have different settings for a given parameter, each can be scored to generate a corresponding evaluation, and the setting with the highest score (or lowest score) can be selected to be used in the offering configuration 490 for the parameter. The scoring can be based on, and/or indicative of, for instance, how popular or well-liked the setting is with other merchants, partner entities, industries, and/or users.

FIG. 5 is a block diagram illustrating an example of a configuration processing system 500 for intelligent customization of settings in an offering configuration 505 based on elements of user information 510 to generate a customized offering configuration 550. The offering configuration 505 is an example of the offering configuration 240. The user information 510 can be, for example, information received from the user 245 or otherwise about the user 245 (e.g. received via a user interface, from the special-purpose user management computer system(s) 250, from the special-purpose decisioning computer system(s) 255, and/or from the AI engine(s) 265).

Like in FIG. 4, the offering configuration 505 is shown having settings for three different parameters, specifically a setting A 520 for a first parameter (top row), a setting B 525 for a second parameter (middle row), and a setting C 530 for a third parameter (bottom row). The user information 510 can include various elements of information about the user, for instance including user preferences of the user, historical transactions associated with the user, and the like. The various elements of user information 510 can relate to the various parameters. For instance, if one parameter is APR and another is term, different elements might include preferences for APR or term, or values for APR or term that the user has received in previous transactions. In this way, elements of user information 510 can be specific to certain parameters.

The configuration processing system 500 includes one or more special-purpose customization computer system(s) 580, which can include, for instance, the special-purpose user management computer system(s) 250, the special-purpose decisioning computer system(s) 255, and/or the AI engine(s) 265, the special-purpose configuration control system 220, or a combination thereof. The special-purpose customization computer system(s) 580 are configured to, and can, customize the offering configuration 505 based on the user information 510 to generate a customized offering configuration 550 that is customized, personalized, and/or tailored to the user associated with the user information 510.

For instance, for the first parameter (top row), the special-purpose customization computer system(s) 580 customizes the setting A 520 of the offering configuration 505 based on the element A 535 (of the user information 510) to generate the customized setting A 550 for the customized offering configuration 550. For the second parameter (middle row), the special-purpose customization computer system(s) 580 maintains the setting B 525 from the offering configuration 505 as-is in the customized offering configuration 550, for instance based on the element B 540 (of the user information 510) matching the setting B 525 or indicating a preference to go along with what is indicated in the offering configuration 505 for at least the second parameter. In some examples, multiple elements of the user information 510 can pertain to a specific parameter, or vice versa. For instance, for the third parameter (bottom row), the special-purpose customization computer system(s) 580 customizes the setting C 530 of the offering configuration 505 based on the element B 540 and the element C 545 (in the user information 510) to generate the customized setting C 555.

FIG. 6 is a block diagram illustrating an example of a machine learning system 600 for training and use of one or more machine learning model(s) 625 used to generate one or more offering configurations 635, and/or to customize the one or more offering configurations to generate one or more customized offering configurations 640. The machine learning system 600 a machine learning (ML) engine 620 that generates, trains, uses, and/or updates one or more ML model(s) 625. The ML model(s) 625 can include, for instance, at least one neural network (NN), at least one convolutional neural network (CNN), at least one time delay neural network (TDNN), at least one deep network (DN), at least one autoencoder (AE), at least one variational autoencoder (VAE), at least one deep belief net (DBN), at least one recurrent neural network (RNN), at least one generative adversarial network (GAN), at least one conditional generative adversarial network (cGAN), at least one feed-forward network, at least one network having fully connected layers, at least one trained support vector machine (SVM), at least one trained random forest (RF), at least one computer vision (CV) system, at least one autoregressive (AR) model, at least one Sequence-to-Sequence (Seq2Seq) model, at least one large language models (LLM), at least one deep learning system, at least one classifier, at least one transformer, or at least one combination thereof. In examples where the ML model(s) 625 include LLMs, the LLMs can include, for instance, a Generative Pre-Trained Transformer (GPT) (e.g., GPT-2, GPT-3, GPT-3.5, GPT-4, etc.), DaVinci or a variant thereof, an LLM using Massachusetts Institute of Technology (MIT)® langchain, Pathways Language Model (PaLM), Large Language Model Meta® AI (LLaMA), Language Model for Dialogue Applications (LaMDA), Bidirectional Encoder Representations from Transformers (BERT), Falcon (e.g., 40B, 7B, 1B), Orca, Phi-1, StableLM, variant(s) of any of the previously-listed LLMs, or a combination thereof.

Within FIG. 6, a graphic representing the ML model(s) 625 illustrates a set of circles connected to one another. Each of the circles can represent a node, a neuron, a perceptron, a layer, a portion thereof, or a combination thereof. The circles are arranged in columns. The leftmost column of white circles represent an input layer. The rightmost column of white circles represent an output layer. Two columns of shaded circled between the leftmost column of white circles and the rightmost column of white circles each represent hidden layers. An ML model can include more or fewer hidden layers than the two illustrated, but includes at least one hidden layer. In some examples, the layers and/or nodes represent interconnected filters, and information associated with the filters is shared among the different layers with each layer retaining information as the information is processed. The lines between nodes can represent node-to-node interconnections along which information is shared. The lines between nodes can also represent weights (e.g., numeric weights) between nodes, which can be tuned, updated, added, and/or removed as the ML model(s) 625 are trained and/or updated. In some cases, certain nodes (e.g., nodes of a hidden layer) can transform the information of each input node by applying activation functions (e.g., filters) to this information, for instance applying convolutional functions, downscaling, upscaling, data transformation, and/or any other suitable functions.

In some examples, the ML model(s) 625 can include a feed-forward network, in which case there are no feedback connections where outputs of the network are fed back into itself. In some cases, the ML model(s) 625 can include a recurrent neural network, which can have loops that allow information to be carried across nodes while reading in input. In some cases, the network can include a convolutional neural network, which may not link every node in one layer to every other node in the next layer.

One or more input(s) 605 can be provided to the ML model(s) 625. The ML model(s) 625 can be trained by the ML engine 620 (e.g., based on training data 660) to generate one or more output(s) 630. In some examples, the input(s) 605 include configuration(s) 610. The configuration(s) 610 can include, for instance, any of the configurations of FIG. 1, the product type configuration 225, the partner configuration 230, the local configuration 235, any of the configurations of FIG. 3, the product type configuration 405, the partner configuration 410, the local configuration 415, other configurations or setting discussed herein, or a combination thereof. In some examples, the configuration(s) 610 can include offering configurations, such as the offering configuration 240, the offering configuration 490, and/or the offering configuration 505, for instance where the ML model(s) 625 are being used to update, modify, and/or customize an offering configuration.

The output(s) 630 generated by the ML model(s) 1125 in response to input of the input(s) 605 (e.g., in response to the configuration(s) 610) into the ML model(s) 1125 can include one or more offering configuration(s) 635, such as the offering configuration 240, the offering configuration 490, and/or the offering configuration 505. The ML model(s) 625 can generate the offering configuration(s) 635 based on the configuration(s) 610 and/or other types of input(s) 605, for instance based on selection(s) and/or combination(s) as discussed with respect to FIG. 2, FIG. 3, and/or FIG. 4 (e.g., selection 460, selection 465, combination 470). In some examples, the offering configuration(s) 635 can be used as input(s) 605 to the ML model(s) 625 (e.g., as one of the configuration(s) 610) for generating future offering configuration(s) 635, for generating customized offering configuration(s) 640, and/or other output(s) 630. In some examples, at least some of the configuration(s) 610 in the input(s) 605 represent previously-generated offering configuration(s) that are input into the ML model(s) 625 to generate the offering configuration(s) 635, the customized offering configuration(s) 640, and/or other output(s) 630. In some examples, based on receipt of the input(s) 605, the ML model(s) 625 can generate the offering configuration(s) 635 at least in part using generative artificial intelligence (AI) content generation techniques, for instance using an LLM to generate custom text.

The output(s) 630 generated by the ML model(s) 625 in response to input of the input(s) 605 (e.g., in response to the configuration(s) 610 and/or the user information 615) into the ML model(s) 625 can include customized offering configuration(s) 640, as in the customized offering configuration 550 or a customized variant of the offering configuration 240 that is customized for the user 245. The ML model(s) 625 can generate the customized offering configuration(s) 640 based on the configuration(s) 610, the user information 615 (e.g., user information 510), and/or other types of input(s) 605. In some examples, based on receipt of the input(s) 605, the ML model(s) 625 can generate the customized offering configuration(s) 640 by customizing elements of an offering configuration (e.g., offering configuration 635 that was previously generated) from the configuration(s) 610 based on the user information 615, for instance as illustrated in FIG. 5. In some examples, based on receipt of the input(s) 605, the ML model(s) 625 can generate the customized offering configuration(s) 640 using generative artificial intelligence (AI) content generation techniques, for instance using an LLM to generate custom text.

In some examples, the ML system that includes the ML engine 620 and/or ML model(s) 625 adds the offering configuration(s) 635 and/or the customized offering configuration(s) 640 to a data store that is configured to store one or more configurations, such as the offering data store 125, entity data store 135, offering data store 145, mapping data store(s) 155, special-purpose configuration control system 220, data stores 270, data store 345. Data can be drawn from these data store(s) to use as input(s) 605 for the ML model(s) 625 for generating future offering configuration(s) 635, customized offering configuration(s) 640, and/or other output(s) 630.

In some examples, the ML system repeats the process illustrated in FIG. 6 multiple times to generate the output(s) 630 in multiple passes, using some of the output(s) 630 from earlier passes as some of the input(s) 605 in later passes. For instance, in an illustrative example, in a first pass, the ML model(s) 625 can generate the offering configuration(s) 635 based on input of the configuration(s) 610 into the ML model(s) 625. In a second pass, the ML model(s) 625 can add (e.g., append) the offering configuration(s) 635 to the configuration(s) 610, and can generate the customized offering configuration(s) 640 based on input of the configuration(s) 610 (updated to include the offering configuration(s) 635 from the first pass) and the user information 615 into the ML model(s) 625.

In some examples, the ML system includes one or more feedback engine(s) 645 that generate and/or provide feedback 650 about the output(s) 630. In some examples, the feedback 650 indicates how well the output(s) 630 align to corresponding expected output(s), how well the output(s) 630 serve their intended purpose, or a combination thereof. In some examples, the feedback engine(s) 645 include loss function(s), reward model(s) (e.g., other ML model(s) that are used to score the output(s) 630), discriminator(s), error function(s) (e.g., in back-propagation), user interface feedback received via a user interface from a user, or a combination thereof. In some examples, the feedback 650 can include one or more alignment score(s) that score a level of alignment between the output(s) 630 and the expected output(s) and/or intended purpose.

The ML engine 620 of the ML system can update (further train) the ML model(s) 625 based on the feedback 650 to perform an update 655 (e.g., further training) of the ML model(s) 625 based on the feedback 650. In some examples, the feedback 650 includes positive feedback, for instance indicating that the output(s) 630 closely align with expected output(s) and/or that the output(s) 630 serve their intended purpose. In some examples, the feedback 650 includes negative feedback, for instance indicating a mismatch between the output(s) 630 and the expected output(s), and/or that the output(s) 630 do not serve their intended purpose. For instance, high amounts of loss and/or error (e.g., exceeding a threshold) can be interpreted as negative feedback, while low amounts of loss and/or error (e.g., less than a threshold) can be interpreted as positive feedback. Similarly, high amounts of alignment (e.g., exceeding a threshold) can be interpreted as positive feedback, while low amounts of alignment (e.g., less than a threshold) can be interpreted as negative feedback. In response to positive feedback in the feedback 650, the ML engine 620 can perform the update 655 to update the ML model(s) 625 to strengthen and/or reinforce weights associated with generation of the output(s) 630 to encourage the ML engine 620 to generate similar output(s) 630 given similar input(s) 605. In response to negative feedback in the feedback 650, the ML engine 620 can perform the update 655 to update the ML model(s) 625 to weaken and/or remove weights associated with generation of the output(s) 630 to discourage the ML engine 620 from generating similar output(s) 630 given similar input(s) 605.

In some examples, the ML engine 620 can also perform an initial training of the ML model(s) 625 before the ML model(s) 625 are used to generate the output(s) 630 based on the input(s) 605. During the initial training, the ML engine 620 can train the ML model(s) 625 based on training data 660. In some examples, the training data 660 includes examples of input(s) (of any input types discussed with respect to the input(s) 605), output(s) (of any output types discussed with respect to the output(s) 630), and/or feedback (of any feedback types discussed with respect to the feedback 650). In an illustrative example, the training data 660 can include configurations (as in the configuration(s) 610), an offering configuration that corresponds to the input configurations (as in the offering configuration(s) 635), and feedback indicating whether the offering configuration is a good or bad score given the input configurations. In a second illustrative example, the training data 660 can include configurations that include an offering configuration (as in the configuration(s) 610), user information (as in the user information 615), a customized offering configuration that is based on the offering configuration from the input configurations and that is based on the user information (as in the customized offering configuration 640), and feedback indicating whether the customized offering configuration is a good or bad customized offering configuration given the input configurations and/or user information. In some cases, positive feedback in the training data 660 can be used to perform positive training, to encourage the ML model(s) 625 to generate output(s) similar to the output(s) in the training data given input of the corresponding input(s) in the training data. In some cases, negative feedback in the training data 660 can be used to perform negative training, to discourage the ML model(s) 625 from generate output(s) similar to the output(s) in the training data given input of the corresponding input(s) in the training data.

FIG. 7 is a flow diagram illustrating a process 700 for automated enrollment orchestration. The process 700 may be performed by an enrollment orchestration system. In some examples, the enrollment orchestration system can include, for example, the transaction processing system 100, the configuration processing system 200, the data architecture 300, the configuration processing system 400, the configuration processing system 500, the machine learning system 600, the computing system 800, the processor 810, and sub-system or component of any of the previously-listed systems, an apparatus, a system, a non-transitory computer-readable medium coupled to a processor, or a combination thereof.

At operation 705, the enrollment orchestration system (or a component or subsystem thereof) is configured to, and can, identify an offering to be offered by an entity (e.g., a merchant, a store). The offering is to be part of a product category (e.g., a category of financial product).

At operation 710, the enrollment orchestration system (or a component or subsystem thereof) is configured to, and can, retrieve a predetermined product category configuration associated with the product category. The predetermined product category configuration includes a first set of one or more settings for offerings in the product category.

At operation 715, the enrollment orchestration system (or a component or subsystem thereof) is configured to, and can, retrieve a predetermined entity configuration associated with the entity. The predetermined entity configuration includes a second set of one or more settings for offerings associated with the entity.

At operation 720, the enrollment orchestration system (or a component or subsystem thereof) is configured to, and can, analyze information associated with the offering to generate an evaluation of the offering relative to the predetermined product category configuration and the predetermined entity configuration.

At operation 725, the enrollment orchestration system (or a component or subsystem thereof) is configured to, and can, generate an offering configuration for the offering by combining a subset of the first set of one or more settings with a subset of the second set of one or more settings based on the evaluation. The offering configuration includes a third set of settings.

At operation 730, the enrollment orchestration system (or a component or subsystem thereof) is configured to, and can, provide the offering on behalf of the entity and according to the third set of settings.

In some examples, providing the offering includes outputting information about the offering using an output device. For instance, outputting the information about the offering can include displaying the information about the offering using a display. Outputting the information about the offering can also include transmitting the information about the offering to a recipient device using a communication interface.

At operation 735, the enrollment orchestration system (or a component or subsystem thereof) is configured to, and can, update an analysis engine used to generate the evaluation based on feedback associated with the offering as provided on behalf of the entity.

In some examples, the enrollment orchestration system (or a component or subsystem thereof) is configured to, and can, receive user information (e.g., user information 510, user information 615) associated with a user (e.g., user 245). The enrollment orchestration system can determine, based on an analysis of user information and the third set of settings for the offering in the offering configuration, that the user is eligible for the offering. In some examples, the providing of the offering (as in operation 730) includes providing the offering to the user.

In some examples, the enrollment orchestration system (or a component or subsystem thereof) is configured to, and can, customize the offering for a user (e.g., user 245) according to user information (e.g., user information 510, user information 615) using a customization engine before providing the offering (e.g., according to a customized offering configuration 550 and/or customized offering configuration 640) to the user. In some examples, the enrollment orchestration system (or a component or subsystem thereof) is configured to, and can, update the customization engine based on the feedback (e.g., based on feedback 650).

In some examples, the customizing of the offering is performed using a trained machine learning model (e.g., one of the ML model(s) 625) based on input of the third set of settings for the offering (e.g., configuration(s) 610) and the user information (e.g., user information 615) to the trained machine learning model (e.g., as input(s) 605), and the updating of the customization engine includes further training of the trained machine learning model (e.g., the update 655) based on the feedback (e.g., the feedback 650).

In some examples, the combining (of operation 725) includes inputting the predetermined product category configuration and the predetermined entity configuration (e.g., as configuration(s) 610) into a trained machine learning model (e.g., one of the ML model(s) 625). In some examples, the updating of the analysis engine includes further training of the trained machine learning model (e.g., the update 655) based on the feedback (e.g., the feedback 650).

In some examples, the combining (of operation 725) includes selecting a setting (e.g., as in selection 460 and/or selection 465) to include in the offering configuration (e.g., offering configuration 490) from a set that includes a first setting and a second setting. The first setting is one of the first set of one or more settings. The second setting is one of the second set of one or more settings. In some examples, the selecting of the setting is based on a hierarchy between the predetermined product category configuration and the predetermined entity configuration. In some examples, the enrollment orchestration system (or a component or subsystem thereof) is configured to, and can, evaluate the first setting to determine a first score for the first setting, and evaluate the second setting to determine a second score for the second setting, where the selecting is based on a comparison between the first score and the second score. In some examples, the selecting of the setting is based on the setting being included in at least a majority of a plurality of configurations (e.g., as in the selection 460), and the plurality of configurations include at least the predetermined product category configuration and the predetermined entity configuration.

In some examples, the combining (of operation 725) includes generating a setting to include in the offering configuration by merging at least one aspect of a first setting with at least one aspect of a second setting (e.g., as in the combination 470), and the first setting is one of the first set of one or more settings, and wherein the second setting is one of the second set of one or more settings.

In some examples, the enrollment orchestration system (or a component or subsystem thereof) is configured to, and can, retrieve an additional configuration that includes a fourth set of one or more settings. The combining (of operation 725) includes combining at least the subset of the first set of one or more settings with at least the subset of the second set of one or more settings and with at least a subset of the fourth set of one or more settings to generate the offering configuration for the offering.

In some examples, wherein the first set of one or more settings is a first set of one or more rules, the second set of one or more settings is a second set of one or more rules, and the third set of one or more settings is a third set of one or more rules.

In some examples, the analyzing (of operation 720) includes comparing the predetermined product category configuration and the predetermined entity configuration to identify one or more differences between the predetermined product category configuration and the predetermined entity configuration.

In some examples, the processes described herein (e.g., the respective processes of FIGS. 1, 2, 3, 4, 5, 6, the process 700, and/or other processes described herein) may be performed by a computing device or apparatus. In some examples, the processes described herein can be performed by the transaction processing system 100, the configuration processing system 200, the data architecture 300, the configuration processing system 400, the configuration processing system 500, the machine learning system 600, the enrollment orchestration system that performs the process 700, the computing system 800, the processor 810, and sub-system or component of any of the previously-listed systems, an apparatus, a system, a non-transitory computer-readable medium coupled to a processor, or a combination thereof.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes described herein are illustrated as logical flow diagrams, block diagrams, or conceptual diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

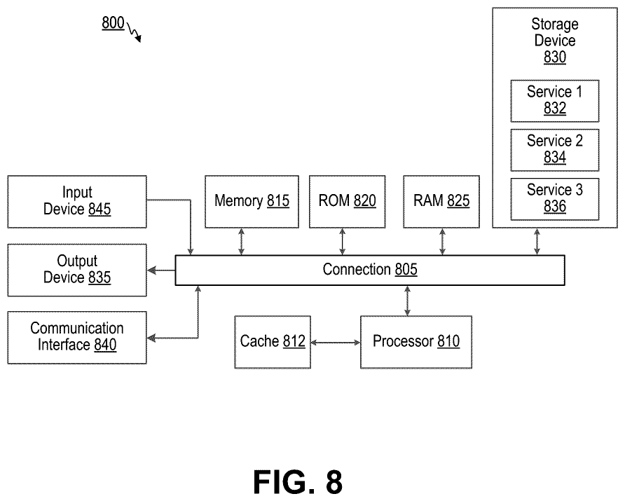

FIG. 8 is a diagram illustrating an example of a system for implementing certain aspects of the present technology. In particular, FIG. 8 illustrates an example of computing system 800, which can be for example any computing device making up internal computing system, a remote computing system, a camera, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some aspects, computing system 800 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 800 includes at least one processing unit (CPU or processor) 810 and connection 805 that couples various system components including system memory 815, such as read-only memory (ROM) 820 and random access memory (RAM) 825 to processor 810. Computing system 800 can include a cache 812 of high-speed memory connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some aspects, a hardware service that performs a particular function can include the software component stored in a computer-readable medium in connection with the necessary hardware components, such as processor 810, connection 805, output device 835, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

### Illustrative Aspects of the Disclosure Include:

Aspect 1. An method for automated enrollment orchestration, the method comprising: identifying an offering to be offered by an entity, wherein the offering is part of a product category; retrieving a predetermined product category configuration associated with the product category, wherein the predetermined product category configuration includes a first set of one or more settings for offerings in the product category; retrieving a predetermined entity configuration associated with the entity, wherein the predetermined entity configuration includes a second set of one or more settings for offerings associated with the entity; analyzing information associated with the offering to generate an evaluation of the offering relative to the predetermined product category configuration and the predetermined entity configuration; generating an offering configuration for the offering by combining a subset of the first set of one or more settings with a subset of the second set of one or more settings based on the evaluation, wherein the offering configuration includes a third set of settings; providing the offering on behalf of the entity and according to the third set of settings; and updating an analysis engine used to generate the evaluation based on feedback associated with the offering as provided on behalf of the entity.

Aspect 2. The method of Aspect 1, further comprising: receiving user information associated with a user; and determining, based on an analysis of user information and the third set of settings for the offering in the offering configuration, that the user is eligible for the offering, wherein the providing of the offering includes providing the offering to the user.

Aspect 3. The method of any of Aspects 1 to 2, further comprising: customizing the offering for the user according to the user information using a customization engine before providing the offering to the user.

Aspect 4. The method of any of Aspects 1 to 3, further comprising: updating the customization engine based on the feedback.

Aspect 5. The method of any of Aspects 1 to 4, wherein the customizing of the offering is performed using a trained machine learning model based on input of the third set of settings for the offering and the user information to the trained machine learning model, and wherein the updating of the customization engine includes further training of the trained machine learning model based on the feedback.

Aspect 6. The method of any of Aspects 1 to 5, wherein the combining includes inputting the predetermined product category configuration and the predetermined entity configuration into a trained machine learning model.

Aspect 7. The method of any of Aspects 1 to 6, wherein the updating of the analysis engine includes further training of the trained machine learning model based on the feedback.

Aspect 8. The method of any of Aspects 1 to 7, wherein the combining includes selecting a setting to include in the offering configuration from a set that includes a first setting and a second setting, wherein the first setting is one of the first set of one or more settings, and wherein the second setting is one of the second set of one or more settings.

Aspect 9. The method of any of Aspects 1 to 8, wherein the selecting of the setting is based on a hierarchy between the predetermined product category configuration and the predetermined entity configuration.

Aspect 10. The method of any of Aspects 1 to 9, further comprising: evaluating the first setting to determine a first score for the first setting; and evaluating the second setting to determine a second score for the second setting, wherein the selecting is based on a comparison between the first score and the second score.

Aspect 11. The method of any of Aspects 1 to 10, wherein the selecting of the setting is based on the setting being included in at least a majority of a plurality of configurations, wherein the plurality of configurations include at least the predetermined product category configuration and the predetermined entity configuration.

Aspect 12. The method of any of Aspects 1 to 11, wherein the combining includes generating a setting to include in the offering configuration by merging at least one aspect of a first setting with at least one aspect of a second setting, wherein the first setting is one of the first set of one or more settings, and wherein the second setting is one of the second set of one or more settings.

Aspect 13. The method of any of Aspects 1 to 12, further comprising: retrieving an additional configuration that includes a fourth set of one or more settings, wherein the combining includes combining at least the subset of the first set of one or more settings with at least the subset of the second set of one or more settings and with at least a subset of the fourth set of one or more settings to generate the offering configuration for the offering.

Aspect 14. The method of any of Aspects 1 to 13, wherein the first set of one or more settings is a first set of one or more rules, wherein the second set of one or more settings is a second set of one or more rules, and wherein the third set of one or more settings is a third set of one or more rules.

Aspect 15. The method of any of Aspects 1 to 14, wherein the analyzing includes comparing the predetermined product category configuration and the predetermined entity configuration to identify one or more differences between the predetermined product category configuration and the predetermined entity configuration.

Aspect 16. An apparatus for automated enrollment orchestration, the apparatus comprising: at least one memory; and at least one processor coupled to the at least one memory, the at least one processor configured to: identify an offering to be offered by an entity, wherein the offering is part of a product category; retrieve a predetermined product category configuration associated with the product category, wherein the predetermined product category configuration includes a first set of one or more settings for offerings in the product category; retrieve a predetermined entity configuration associated with the entity, wherein the predetermined entity configuration includes a second set of one or more settings for offerings associated with the entity; analyze information associated with the offering to generate an evaluation of the offering relative to the predetermined product category configuration and the predetermined entity configuration; generate an offering configuration for the offering by combining a subset of the first set of one or more settings with a subset of the second set of one or more settings based on the evaluation, wherein the offering configuration includes a third set of settings; provide the offering on behalf of the entity and according to the third set of settings; and update an analysis engine used to generate the evaluation based on feedback associated with the offering as provided on behalf of the entity.

Aspect 17. The apparatus of Aspect 16, the at least one processor configured to: receive user information associated with a user; and determine, based on an analysis of user information and the third set of settings for the offering in the offering configuration, that the user is eligible for the offering, wherein the providing of the offering includes providing the offering to the user.

Aspect 18. The apparatus of any of Aspects 16 to 17, the at least one processor configured to: customize the offering for the user according to the user information using a customization engine before providing the offering to the user.

Aspect 19. The apparatus of any of Aspects 16 to 18, the at least one processor configured to: update the customization engine based on the feedback.

Aspect 20. The apparatus of any of Aspects 16 to 19, wherein the customizing of the offering is performed using a trained machine learning model based on input of the third set of settings for the offering and the user information to the trained machine learning model, and wherein the updating of the customization engine includes further training of the trained machine learning model based on the feedback.

Aspect 21. The apparatus of any of Aspects 16 to 20, wherein the combining includes inputting the predetermined product category configuration and the predetermined entity configuration into a trained machine learning model.

Aspect 22. The apparatus of any of Aspects 16 to 21, wherein the updating of the analysis engine includes further training of the trained machine learning model based on the feedback.

Aspect 23. The apparatus of any of Aspects 16 to 22, wherein the combining includes selecting a setting to include in the offering configuration from a set that includes a first setting and a second setting, wherein the first setting is one of the first set of one or more settings, and wherein the second setting is one of the second set of one or more settings.

Aspect 24. The apparatus of any of Aspects 16 to 23, wherein the selecting of the setting is based on a hierarchy between the predetermined product category configuration and the predetermined entity configuration.

Aspect 25. The apparatus of any of Aspects 16 to 24, the at least one processor configured to: evaluate the first setting to determine a first score for the first setting; and evaluate the second setting to determine a second score for the second setting, wherein the selecting is based on a comparison between the first score and the second score.

Aspect 26. The apparatus of any of Aspects 16 to 25, wherein the selecting of the setting is based on the setting being included in at least a majority of a plurality of configurations, wherein the plurality of configurations include at least the predetermined product category configuration and the predetermined entity configuration.

Aspect 27. The apparatus of any of Aspects 16 to 26, wherein the combining includes generating a setting to include in the offering configuration by merging at least one aspect of a first setting with at least one aspect of a second setting, wherein the first setting is one of the first set of one or more settings, and wherein the second setting is one of the second set of one or more settings.

Aspect 28. The apparatus of any of Aspects 16 to 27, the at least one processor configured to: retrieve an additional configuration that includes a fourth set of one or more settings, wherein the combining includes combining at least the subset of the first set of one or more settings with at least the subset of the second set of one or more settings and with at least a subset of the fourth set of one or more settings to generate the offering configuration for the offering.

Aspect 29. The apparatus of any of Aspects 16 to 28, wherein the first set of one or more settings is a first set of one or more rules, wherein the second set of one or more settings is a second set of one or more rules, and wherein the third set of one or more settings is a third set of one or more rules.

Aspect 30. The apparatus of any of Aspects 16 to 29, wherein the analyzing includes comparing the predetermined product category configuration and the predetermined entity configuration to identify one or more differences between the predetermined product category configuration and the predetermined entity configuration.

Aspect 31. A non-transitory computer-readable medium having stored thereon instructions that, when executed by one or more processors, cause the one or more processors to perform operations according to any of Aspects 1 to 30.

Aspect 32. An apparatus comprising one or more means for performing operations according to any of Aspects 1 to 30.

What is claimed is:

1. A method for automated enrollment orchestration, the method comprising:
identifying an offering to be offered by an entity, wherein the offering is part of a product category;
retrieving a predetermined product category configuration associated with the product category, wherein the predetermined product category configuration includes a first set of one or more settings for offerings in the product category;
retrieving a predetermined entity configuration associated with the entity, wherein the predetermined entity configuration includes a second set of one or more settings for offerings associated with the entity;
analyzing information associated with the offering to generate an evaluation of the offering relative to the predetermined product category configuration and the predetermined entity configuration;
generating an offering configuration for the offering by combining a subset of the first set of one or more settings with a subset of the second set of one or more settings based on the evaluation, wherein the offering configuration includes a third set of settings;
providing the offering on behalf of the entity and according to the third set of settings; and
updating an analysis engine used to generate the evaluation based on feedback associated with the offering as provided on behalf of the entity.

2. The method of claim 1, further comprising:
receiving user information associated with a user; and
determining, based on an analysis of user information and the third set of settings for the offering in the offering configuration, that the user is eligible for the offering, wherein the providing of the offering includes providing the offering to the user.

3. The method of claim 1, further comprising:
customizing the offering for a user according to user information using a customization engine before providing the offering to the user.

4. The method of claim 3, further comprising:
updating the customization engine based on the feedback.

5. The method of claim 4, wherein the customizing of the offering is performed using a trained machine learning model based on input of the third set of settings for the offering and the user information to the trained machine learning model, and wherein the updating of the customization engine includes further training of the trained machine learning model based on the feedback.

6. The method of claim 1, wherein the combining includes inputting the predetermined product category configuration and the predetermined entity configuration into a trained machine learning model.

7. The method of claim 6, wherein the updating of the analysis engine includes further training of the trained machine learning model based on the feedback.

8. The method of claim 1, wherein the combining includes selecting a setting to include in the offering configuration from a set that includes a first setting and a second setting, wherein the first setting is one of the first set of one or more settings, and wherein the second setting is one of the second set of one or more settings.

9. The method of claim 8, wherein the selecting of the setting is based on a hierarchy between the predetermined product category configuration and the predetermined entity configuration.

10. The method of claim 8, further comprising:
evaluating the first setting to determine a first score for the first setting; and
evaluating the second setting to determine a second score for the second setting, wherein the selecting is based on a comparison between the first score and the second score.

11. The method of claim 8, wherein the selecting of the setting is based on the setting being included in at least a majority of a plurality of configurations, wherein the plurality of configurations include at least the predetermined product category configuration and the predetermined entity configuration.

12. The method of claim 1, wherein the combining includes generating a setting to include in the offering configuration by merging at least one aspect of a first setting with at least one aspect of a second setting, wherein the first setting is one of the first set of one or more settings, and wherein the second setting is one of the second set of one or more settings.

13. The method of claim 1, further comprising:
retrieving an additional configuration that includes a fourth set of one or more settings, wherein the combining includes combining at least the subset of the first set of one or more settings with at least the subset of the second set of one or more settings and with at least a subset of the fourth set of one or more settings to generate the offering configuration for the offering.

14. The method of claim 1, wherein the first set of one or more settings is a first set of one or more rules, wherein the second set of one or more settings is a second set of one or more rules, and wherein the third set of one or more settings is a third set of one or more rules.

15. The method of claim 1, wherein the analyzing includes comparing the predetermined product category configuration and the predetermined entity configuration to identify one or more differences between the predetermined product category configuration and the predetermined entity configuration.

16. An apparatus for automated enrollment orchestration, the apparatus comprising:
at least one memory; and
at least one processor coupled to the at least one memory, the at least one processor configured to:
identify an offering to be offered by an entity, wherein the offering is part of a product category;
retrieve a predetermined product category configuration associated with the product category, wherein the predetermined product category configuration includes a first set of one or more settings for offerings in the product category;
retrieve a predetermined entity configuration associated with the entity, wherein the predetermined entity configuration includes a second set of one or more settings for offerings associated with the entity;
analyze information associated with the offering to generate an evaluation of the offering relative to the predetermined product category configuration and the predetermined entity configuration;
generate an offering configuration for the offering by combining a subset of the first set of one or more settings with a subset of the second set of one or more settings based on the evaluation, wherein the offering configuration includes a third set of settings;
provide the offering on behalf of the entity and according to the third set of settings; and
update an analysis engine used to generate the evaluation based on feedback associated with the offering as provided on behalf of the entity.

17. The apparatus of claim 16, the at least one processor configured to:
receive user information associated with a user; and
determine, based on an analysis of user information and the third set of settings for the offering in the offering configuration, that the user is eligible for the offering, wherein the providing of the offering includes providing the offering to the user.

18. The apparatus of claim 16, the at least one processor configured to:
customize the offering for a user according to user information using a customization engine before providing the offering to the user.

19. The apparatus of claim 18, the at least one processor configured to:
update the customization engine based on the feedback.

20. The apparatus of claim 19, wherein the customizing of the offering is performed using a trained machine learning model based on input of the third set of settings for the offering and the user information to the trained machine learning model, and wherein the updating of the customization engine includes further training of the trained machine learning model based on the feedback.

21. The apparatus of claim 16, wherein the combining includes inputting the predetermined product category configuration and the predetermined entity configuration into a trained machine learning model.

22. The apparatus of claim 21, wherein the updating of the analysis engine includes further training of the trained machine learning model based on the feedback.

23. The apparatus of claim 16, wherein the combining includes selecting a setting to include in the offering configuration from a set that includes a first setting and a second setting, wherein the first setting is one of the first set of one or more settings, and wherein the second setting is one of the second set of one or more settings.

24. The apparatus of claim 23, wherein the selecting of the setting is based on a hierarchy between the predetermined product category configuration and the predetermined entity configuration.

25. The apparatus of claim 23, the at least one processor configured to:
evaluate the first setting to determine a first score for the first setting; and
evaluate the second setting to determine a second score for the second setting, wherein the selecting is based on a comparison between the first score and the second score.

26. The apparatus of claim 23, wherein the selecting of the setting is based on the setting being included in at least a majority of a plurality of configurations, wherein the plurality of configurations include at least the predetermined product category configuration and the predetermined entity configuration.

27. The apparatus of claim 16, wherein the combining includes generating a setting to include in the offering configuration by merging at least one aspect of a first setting with at least one aspect of a second setting, wherein the first setting is one of the first set of one or more settings, and wherein the second setting is one of the second set of one or more settings.

28. The apparatus of claim 16, the at least one processor configured to:
retrieve an additional configuration that includes a fourth set of one or more settings, wherein the combining includes combining at least the subset of the first set of one or more settings with at least the subset of the second set of one or more settings and with at least a subset of the fourth set of one or more settings to generate the offering configuration for the offering.

29. The apparatus of claim 16, wherein the first set of one or more settings is a first set of one or more rules, wherein the second set of one or more settings is a second set of one or more rules, and wherein the third set of one or more settings is a third set of one or more rules.

30. The apparatus of claim 16, wherein the analyzing includes comparing the predetermined product category configuration and the predetermined entity configuration to identify one or more differences between the predetermined product category configuration and the predetermined entity configuration.
